(19) United States
(12) Patent Application Publication
(10) Pub. No.: US 2022/0047023 A1
(43) Pub. Date: Feb. 17, 2022

(54) Weather Resistant Insulative Apparel Fabrics

(71) Applicant: Xymid, LLC., Midlothian, VA (US)

(72) Inventor: Dimitri Zafiroglu, Centreville, DE (US)

(21) Appl. No.: 17/400,344

(22) Filed: Aug. 12, 2021

Related U.S. Application Data
(60) Provisional application No. 63/064,452, filed on Aug. 12, 2020.

(51) Int. Cl. A41D 31/102; B32B 5/02; B32B 5/06; B32B 5/26; B32B 7/022

(52) U.S. Cl. CPC A41D 31/102; B32B 2307/73; B32B 5/073; B32B 5/026; B32B 5/279; B32B 5/267; B32B 7/022; A41D 2500/10; B32B 2250/20; A41D 2500/30; B32B 2307/712; B32B 2437/00; B32B 2262/0284; B32B 2262/0253; B32B 2262/04; B32B 2307/724; B32B 2307/7265; B32B 2307/728; B32B 5/022

(57) ABSTRACT

A conformable and optionally elastic weather resistant, comfortable fabric provides wind and rain resistance, plus thermal insulation, along with moisture transfer through the fabric, by combining a hydrophobic and dense outer layer with a bulky absorbent middle layer and a thin hydrophobic inner layer, joined by stitching and optionally subsequently shrinking to bulk the structure and re-adjust the openings formed by stitching. The third hydrophobic layer may be omitted and substituted with hydrophobic underlap yarns formed during the stitching process. The method provides high conformability and optionally elastic fit or inelastic pre-adjustable body fit.

### FIELD OF THE INVENTION

The present invention relates to fabrics that provide high thermal insulation and wind and rain resistance with efficient outward moisture transfer, in addition to drapeability, conformability, breathability, and flexibility at relatively low weight and cost.

### BACKGROUND OF THE INVENTION

Durable fabrics providing thermal insulation along with weather resistance at lower weights, with lower overall thickness and high conformability and drapeability usually rely on microfibers laminated or otherwise incorporated into nonwovens, woven or knits, frequently aided by additional processes such as mechanical bulking, or brushing, and further aided by lamination to various breathable membranes.

U.S. published patent application No. 2011/0092122 discusses laminating via adhesive a nanofiber layer between an outer fabric layer and an inner nanofiber fabric layer. The nanofiber layer is a with a basis weight of 10 g/m². The outer layer is a relatively heavy insulating fleece (180 g/m²) or Ripstop fabric (100 g/m²). No provision is made for conformability, and the product is relatively stiff and inelastic.

U.S. published patent application 2007/0245448 discloses a polyester or polyurethane open-cell foam sandwiched between a waterproof and windproof exterior fabric and an open mesh fabric interior layer. These three layers are quilted together. The foam may have different thicknesses to match the anticipated weather conditions and may have a skinned layer adjacent to the exterior fabric and a convoluted surface opposite to the interior. The resulting product is also relatively heavy and inelastic, and lacks a moisture transfer mechanism.

Bulked stitch-bonded and optionally elastic conformable fabrics relying on three-dimensional gathering for bulk and thermal insulation and incorporating selected microfiber substrates have also been used as insulative apparel. U.S. Pat. No. 6,821,601 discloses a non-fibrous polymeric material or metal foil stitch-bonded by contractable yarns, such as elastic Lycra™ yarns, partially oriented synthetic organic polymeric yarns (POY), or textured yarns. As the stitched yarns shrink, they bulk the stitch-bonded material by contracting it to at least 90% of its original planar surface area. When elastic yarns are used the bulked materials remain elastic and the fabrics are usable as fashion apparels, shoes, handbags and accessories. Optionally, a second layer, including a Tyvek™ flash-spun polyethylene plexi-filament layer, is included in the stitch-bonded material. No moisture transfer mechanism across the fabric is provided.

U.S. Pat. No. 7,875,334 discloses stitch-bonded fabrics with a slit substrate that may allow moisture exit and entrance, but still lack a moisture transfer mechanism across the fabric. The substrate can be a woven, a nonwoven, a knit, a stitch-bonded fabric, a polymeric film or a metal foil. The stitch-bonded slotted fabrics can be tensioned so that the lips of the slits part thereby producing varied performances, such as increased breathability with increasing stretch, and aesthetically pleasing effects. These fabrics are usable in non-apparel applications such as mattress cover skirts and as cleaning wipes/towels.

While these fabrics discussed in the '601 and '334 patents are relatively light-weight, they have limited bulk or thickness per unit area weight, and lack the ability to draw body moisture and allow the moisture to be transferred out of the fabrics.

U.S. Pat. No. 6,936,327 also discloses a bulked or gathered stitch-bonded composite using a shrinkable stitching substrate. The stitch-bonded fabric is shrunk to form a fibrous face layer consisting of looped yarns. The bulked composites of the '327 patent are usable as the abrasion resistant face or top layer of floor coverings and the likes, and similarly lack moisture transfer properties.

All of these references are incorporated herein by reference in their entireties.

Hence, there remains a need for conformable, drapeable and durable lightweight wind and rain resistant fabrics, providing high thermal insulation, and the ability to draw moisture and release it outwards.

### SUMMARY OF THE INVENTION

The present invention is directed to a layered fabric, including a relatively thin and dense wind-resistant or wind-blocking, hydrophobic water repellent outer layer, placed over a thick bulky, hydrophilic and resilient mid-layer containing a high percentage of water absorbing preferably cellulosic fibers, and followed by a relatively open and highly permeable hydrophobic inner layer, wherein the three layers are pierced with yarn-carrying stitching needles and attached to each other using stitching yarns. The stitching needles also drive absorbent fibers partially through the highly permeable, open, and hydrophobic inner layer at the stitching perforations, thereby facilitating transfer of moisture to the bulky mid-layer via capillary action and via the attraction of water by the hydrophilic fibers. The moisture is then transferred out of the stitched composite fabric principally or entirely through the stitching perforations in the wind and water resistant, denser and hydrophobic outer layer, as the outer atmosphere would be less humid or drier than inside the garment and air motion would dry the perforations in the outer layer through convection. The highly open inner layer allows moisture to propagate into the absorbent mid-layer between the perforations. Optionally fibers from the middle absorbent layer are partially pre-inserted through the open inner layer all along its bottom by lightly pre-needling into the lower layer to promote moisture transfer between the stitching perforations as well.

The outer layer is preferably a microfiber nonwoven fabric, or a coated or laminated textile fabric allowing a limited passage of air or moisture and yet remaining flexible as opposed to a solid layer such as a film. A suitable outer layer includes, but is not limited to, a commercial nonwoven fabric known as Tyvek™, that has a Frazier air permeability of less than about 5 ft³/ft²/minute. Suitable outer layer may also have a Frazier air permeability value approaching zero or zero. The permeability of the outer layer can be readily increased by providing perforations during the stitching process. Additional perforations can be supplied by unloaded stitching needles between needles loaded with stitching yarns.

The invention is also directed to a process combining the three layers using a stitch-bonding machine or multi-head sewing machine or quilting machine forming rows or other patterns of stitches, optionally followed by the relaxation of tension and/or the application of heat or moisture or both heat and moisture allowing the combined layers to shrink by at least 10% in at least one direction, either machine direction (MD) or transverse direction (XD) or both, causing the thickness of the stitched composite to increase by at least 15%, and the Frazier air permeability to decrease.

The present invention may optionally utilize a shrinkable elastic or inelastic inner layer, in lieu of or in addition to shrinkable elastic or inelastic yarns, causing the upper two layers to gather and bulk out of plane between stitches as the inner technical back surface against the wearer remains relatively smooth. The spacing between stitch perforations in both MD and XD are selected to be as long or as wide as possible to minimize the permeation of water, such as rain, through the outer layer, and to promote bulking the stitched fabrics as the layers buckle out of plane when the product is shrunk in MD or XD. Effectively, this selection of large spaces leads to the use of a smaller “gage” with larger spaces between adjacent stitches, and smaller “CPI” or number of stitches in MD. Preferably, the shrinkable elastic or inelastic stitching yarns are applied under tension. The buckling of the outer layer between stitches around the needle perforation points also masks the outer perforated openings and reduces the exposure of the perforations to rain and wind.

The open inner layer may be eliminated and replaced by the simultaneous formation of a layer of cross-stitched or cross-laid underlaps of hydrophobic yarns along the bottom or technical back, during the stitching process. The cross-laid or stitched underlaps may or may not be shrinkable or elastic.

As another option, an additional separate shrinkable open, inner layer can be placed under or pre-attached to the bottom of the bulky absorbent mid-layer to facilitate shrinkage after stitching. As a further option, a shrinkable open layer can be added above the absorbent layer or below the absorbent layer to facilitate bulking in lieu of or in addition to shrinkable yarns.

The hydrophobic inner layer, whether shrinkable itself or aided by a separate shrinkable layer, or formed by stitched underlaps or laid-in underlaps, is sufficiently open to allow moisture to be absorbed by the hydrophilic fibers of the mid-layer. The mid-layer fibers driven through by the stitching needles further promote the transmission of body moisture into the absorbent mid-layer. Short ends or shallow loops of the fibers of the mid-layer may also protrude through the openings on the inner layer between stitched perforations, further facilitating the outward transfer of body moisture. Furthermore, as another option fibers from the mid-layer can be lightly needle-punched into the open inner layer before layering and stitching for improved moisture transmission.

These and other objects of the present invention are realized by the several embodiments described herein.

An embodiment of the present invention is directed to a conformable composite weather resistant and insulative stitched fabric comprising a hydrophobic, water and wind-resistant outer layer along a technical front, a hydrophilic, fibrous middle layer, and a hydrophobic, open inner layer along a technical back, wherein the outer, middle and inner layers are stitched with yarns

wherein before stitching the outer layer has an initial Frazier air permeability under about 5 ft³/ft²/minute, preferably under about 2.5 ft³/ft²/minute, and optionally approaching 0 ft³/ft²/minute,

wherein the open inner layer has planar openings exposing the lower surface of the middle layer,

wherein at least some of the fibers of the middle layer are projected through the inner layer through the planar openings and through the stitching perforations, and wherein said projected fibers are capable of wicking moisture from below the inner layer through the middle layer and out of the outer layer, and

wherein an overall density of the fabric is lower than about 0.25 g/cm³, preferably lower than about 0.15 g/cm³, more preferably lower than 0.10 g/cm³.

Another embodiment of the present invention is directed to a conformable composite weather resistant and insulative stitched fabric comprising a hydrophobic, water and wind-resistant outer layer along a technical front and a hydrophilic, fibrous middle layer, wherein the outer and middle layers are stitched with yarns and the stitched yarns form a hydrophobic, open inner layer,

wherein the outer layer has an initial Frazier air permeability under about 5 ft³/ft²/minute, preferably under about 2.5 ft³/ft²/minute, and optionally approaching 0 ft³/ft²/minute,

wherein the open inner layer has openings exposing the lower surface of the middle layer,

wherein at least some of the fibers of the middle layer are projected through the open inner layer through the openings and through the stitching perforations, and wherein said projected fibers are capable of wicking moisture from below the inner layer through the middle layer and out of the outer layer, and

wherein an overall density of the fabric is lower than about 0.25 g/cm³, preferably lower than about 0.15 g/cm³, more preferably lower than 0.10 g/cm³.

Alternatively, the open inner layer is formed with cross-laid yarns originating from a separate stitching bar, or the open inner layer is formed with the underlaps of tricot-stitched yarns. Alternatively, the open inner layer may comprise underlap yarns originating from the stitching yarns along the technical back. The underlap yarns may originate from laid-in yarns. In one embodiment, the laid-in yarns are POY yarns, and the stitched fabric is shrunk in a cross direction (XD) by at least 10%. In another embodiment, the shrinkable stitched-in or laid-in yarns are elastic yarns, and the stitched fabric is shrunk in the MD or XD or both by at least 10%, and the stitched fabric is elastic in the MD or XD or both. Advantageously, the bulked stitched fabric is capable of partially stretching in the MD or XD or both without a substantially loss of thickness.

Yet another embodiment is directed to a weather resistant and insulative stitched fabric comprising a hydrophobic, water and wind-resistant outer layer along a technical front, a hydrophilic, fibrous middle layer, and a hydrophobic, open inner layer along a technical back, wherein at least the outer and middle layers are stitched with stitching yarns,

wherein the outer layer has an initial Frazier air permeability value under about 5 ft³/ft²/minute, preferably under about 2.5 ft³/ft²/minute,

wherein the open inner layer has planar openings exposing a lower surface of the middle layer,

wherein at least some of the fibers of the middle layer are projected at least through the inner layer through the stitching perforations, and wherein said projected fibers are capable of wicking moisture from below the inner layer through the middle layer and out of the outer layer, and

wherein an overall density of the stitched fabric is lower than about 0.25 g/cm³, preferably lower than about 0.15 g/cm³.

The open inner layer may comprise a nonwoven layer. Alternatively, the open inner layer may comprise laid-in underlap yarns from the stitching yarns along the technical back. The laid-in underlap yarns may be shrinkable. The shrinkable yarns can be POY yarns, and the stitched fabric is shrunk in a cross direction (XD) by at least 10%. Alternatively, the shrinkable yarns can be elastic yarns, and the stitched fabric is shrunk in both MD and XD by at least 10%, and the stitched fabric is elastic in both MD and XD. The elastic yarns may shrink and bulk the stitched fabric, and the bulked stitched fabric is capable of stretching without substantially change in thickness and without substantial density reduction.

Additionally, the open inner layer may comprise underlap yarns originating from the stitching yarns along the technical back. The underlap yarns may originate from laid-in yarns. In one embodiment, the laid-in yarns are POY yarns, and the stitched fabric is shrunk in a cross direction (XD) by at least 10%. In another embodiment, the shrinkable stitched-in or laid-in yarns are elastic yarns, and the stitched fabric is shrunk in the MD or XD or both by at least 10%, and the stitched fabric is elastic in the MD or XD or both. Advantageously, the bulked stitched fabric is capable of partially stretching in the MD or XD or both without a substantially loss of thickness.

The face layer in the embodiments can be a plexi-filamentary nonwoven layer. The face layer can also be a dense woven, nonwoven or knit fabric. The face layer may also be a reinforced or nonreinforced polymeric film. Alternatively, the face layer is printed before stitching.

Alternatively, the middle layer in the embodiments may contain up to about 20%, preferably up to about 15%, preferably up to about 10% of high-melting resilient high denier fibers in the range from about 3 to about 15 dpf and from about 1.5 to about 4.0-inch cut length. The middle layer may contain up to 20%, preferably up to about 15%, preferably up to about 10% of low-melt single component or bicomponent adhesive fibers providing fiber content in the range from about 2% to about 15% that can melt at temperatures under about 200° C.

The middle layer can be a needle-punched felt. Alternatively, fibers from the middle layer or from a separate absorbent layer are partially inserted into the lower layer before layering and stitching.

Preferably, at least some of the fibers from the middle layer are inserted into the inner layer between the stitching perforations, and wherein said inserted fibers are capable of wicking moisture from below the inner layer through the middle layer and out of the outer layer.

The inner layer may be treated by heat to melt the low-melt fibers.

The stitching yarns may be a composite of a shrinkable yarn and a low-melting yarn. The low-melting yarns add to the durability and to the sealing of the needle penetrations.

The stitched fabric is preferably shrunk and/or bulked with heat or steam in at least one direction by at least about 10%, preferably about 20% and preferably about 30% in the machine direction or transverse direction or both.

### BRIEF DESCRIPTION OF THE DRAWINGS

In the accompanying drawings, which form a part of the specification and are to be read in conjunction therewith and in which like reference numerals are used to indicate like parts in the various views:

FIG. 1A is a schematic of a cross section of three superposed layers, including a dense or solid hydrophobic fabric serving as the outer layer, a bulky absorbent mid-layer, and a low weight, highly open hydrophobic fabric or mesh serving as the inner layer.

FIG. 1B is a schematic representation of the three layers of FIG. 1A after stitching.

FIG. 1C is a schematic representation of the stitched layers of FIG. 1B after shrinking.

FIG. 2A is a schematic of a dense outer layer superposed over an absorbent bulky layer.

FIG. 2B is a schematic of the superposed layers of FIG. 2A after stitching and forming an under-layer of underlaps.

FIG. 2C is a schematic of the stitched composite of FIG. 2B after shrinking.

### DETAILED DESCRIPTION OF THE PREFERRED EMBODIMENTS

In one embodiment, a thin, hydrophobic and durable film or fabric with high resistance to wind and water serves as the outer layer of a stich-bonded comfort apparel fabric on the technical front. Preferably, this outer layer has a Frazier air permeability (FAP) values under 5 ft³/ft²/min, preferably under about 2.5 ft³/ft²/minute, and optionally approaching 0 ft³/ft²/minute or no air permeability. Nonwoven fabrics and their FAB values are discussed in U.S. Pat. No. 5,368,920, which is incorporated herein by reference in its entirety. The '920 patent discloses several examples of fabrics and their FAB values. For example, spunbonded nonwoven fabrics made from continuous fibers with bond distance of 0.38 mm and 0.09 mm have FAB values of 850 and 300-500 ft³/ft²/minute, respectively. A thermal bonded nonwoven of 1.5 denier and 1.5 inch fibers with 0.09 mm bond distance has a FAP value of 300 ft³/ft²/minute, and a hydroentangled nonwoven of 1.5 denier and 1.5 inch fibers with bond distance of 0.06 mm bond distance has a FAP value of 460 ft³/ft²/minute. Hence, the outer layer with FAP values from 0-5 ft³/ft²/minute has very low to no air permeability. The outer layer provides the inventive stitch-bonded fabric its high resistance to wind and rain. As used herein, the outer layer's FAP value does not include any modifications to increase the FAP values, such as perforations caused by stitch-bonding needles with stitching yarns or without yarns, as discussed below.

The outer layer is placed against a relatively loose, bulky and hydrophilic fibrous middle layer with a density under 0.25 g/cm³, preferably under 2.0 g/cm³ or 0.15 g/cm³, more preferably 0.10 g/cm³, and containing a high percentage of absorptive cellulosic fibers.

Preferably, a third layer or an inner layer is positioned on the opposite side of the middle layer. In one embodiment, a protective thin, open and hydrophobic fabric, such as a woven or knit mesh fabric or a low-weight nonwoven fabric, is placed against the opposite side of absorbent mid-layer and serves as the inner face of the composite garment fabric, which would be facing the wearer of the garment, along the technical back. The FAP value of the inner repellent fabric is preferably over 15 ft³/ft²/min. The two or three superposed layers, i.e., the thin outer hydrophobic wind/water resistant layer, the middle absorbent, hydrophilic bulky layer and the protective thin, open hydrophobic inner layer, are stitched using linear “chain” or tricot stitches. The stitching yarns are preferably elastically or inelastically shrinkable yarns. The shrinkable elastic yarns are preferably deployed under high tension. Alternatively, the stitching yarns are partially oriented shrinkable yarns (POY), also fed under tension. The inner fabric may be post-shrinkable eliminating the need of using shrinkable yarns. Some of the absorbent fibers from the absorptive, hydrophilic mid-layer are partially pushed through the highly open inner layer at the stitch insertion points by the stitching needles, establishing a path for body moisture to be wicked outward through the perforations opened by the stitching needles in the wind-resistant face or outer layer.

In another embodiment, laid-in or stitched-in underlaps serve as the hydrophobic inner open layer. The relatively loose absorbent fibers of the absorbent mid-layer are highly exposed to or protrude partially below the laid-in underlaps between the yarn insertion points. The generally absorbent and loose bulky middle layer can advantageously include absorbent or nonabsorbent, long or short, high or low denier fibers enclosed and protected by the two surrounding layers.

The stitched fabric is optionally allowed to shrink with or without added heat as the stitched or laid-in yarns or the shrinkable inner layer shrinks. The shrinkable yarns also tighten around the loose absorbent fibers, and also around the sections of the outer layer between stitch slits, as well as around the inner layer or around the laid-in or stitched-in underlap yarn layer. The stitched fabric is capable of attracting moisture through the open hydrophobic inner layer into the absorbent mid-layer and out through the stitch openings or perforations of the outer layer, aided by the absorbent fibers partially forced through the inner layer by the action of the stitching needles.

Preferably and optionally the laid-in or stitched-in underlaps are also formed with shrinkable and are either elastic or POY yarns. The shrinkage is also optionally two-directional along the surface of the inventive fabrics.

The laid-in yarns or underlaps tend to stay in-plane and shrink in-plane, allowing the formation of a relatively flat and smooth inner surface with the ends of the absorbent fibers from the middle layer projecting through. When a non-shrinking lower open fabric is used and the assembly is shrunk using shrinkable yarns, the lower surface will assume a wavy texture.

In one embodiment, the technical front outer layer or face face is a plexi-filamentary microfiber nonwoven fabric. Alternatively, the outer layer is a dense and hydrophobic bonded or spunlaced nonwoven. In one embodiment, the outer layer is a thin and soft polymeric film or a polymeric membrane. In one embodiment, the outer layer is a thin polymeric film reinforced with a thin nonwoven, knit or woven fabric or a layer of bi-directionally oriented staple or filament fibers.

In another embodiment, the absorbent, hydrophilic, fibrous mid-layer is a lightly needle-punched cross-lapped layer of absorbent fibers such as Rayon or Lyocell. The absorbent fibrous layer may contain up to 25% low melting fibers that are activated after the stitched fabric is shrunk. The absorbent layer may also contain a relatively small percentage of resilient high denier absorbent or nonabsorbent fibers helping to maintain bulk. In one embodiment, the absorbent layer contains up to 25% low-melting fibers melting at a temperature below the melting temperature of the rest of the components in the stitched fabric including the inner fabric or laid-in stitched yarns. In one embodiment, the stitching yarns are a composite of elastic and low melting yarns melting at a temperature below the melting temperature of the rest of the components in the fabric. The middle layer can be any mixture or combination of fibers with a density under about 0.2 g/cm³, preferably under about 0.15 g/cm³ or under about 0.10 g/cm³, a thickness of at least about 2 mm, preferably at least about 2.5 mm or at least about 3 mm, with a basis weight from about 50 to about 150 g/m², preferably from about 75 g/m² to about 125 g/m². Preferably, it contains at least 50 wt. % plant based or cellulosic fibers with a length of at least 20 mm. Preferably, the mid-layer is a lightly needle-punched felt. The envelopment of the absorbent, hydrophilic mid-layer by the outer and inner layers also provides the opportunity to use a small percentage of higher melting, higher denier stiff fibers that can help maintain the bulk, and do not soften and collapse with moisture without creating a roughness on either outer and inner surface. In instances where a small percentage of absorbent fibers such as rayon or lyocell fibers are pre-driven from the middle layer through the open inner layer, the denier of the absorbent fibers is kept substantially lower, and the pre-inserting punching needles relatively fine to avoid the insertion of high-denier stiff fiber ends through the inner layer towards the wearer.

In one embodiment, the inner layer is non-shrinkable or less shrinkable than the stitching yarn system, and the inner layer is buckled and textured offering interrupted contact against the wearer's body and higher comfort. The two levels of shrinkage can be balanced to maintain flatness or produce and adjust texture and three-dimensionality along the bottom.

In another embodiment, a buckled, textured surface of the inner layer is optionally flattened with heat. In one embodiment a flat back-face is lightly touched with a heated there-dimensional tool to create a textured surface. Alternatively, the inner side of the fabric is heat-finished by passing a heated roller having a smooth or patterned face over the buckled, textured inner layer, to stabilize the inner layer and the entire fabric without affecting the outer face layer which, as in the case of plexi-filamentary polyethylene, has a low melting or deformation temperature.

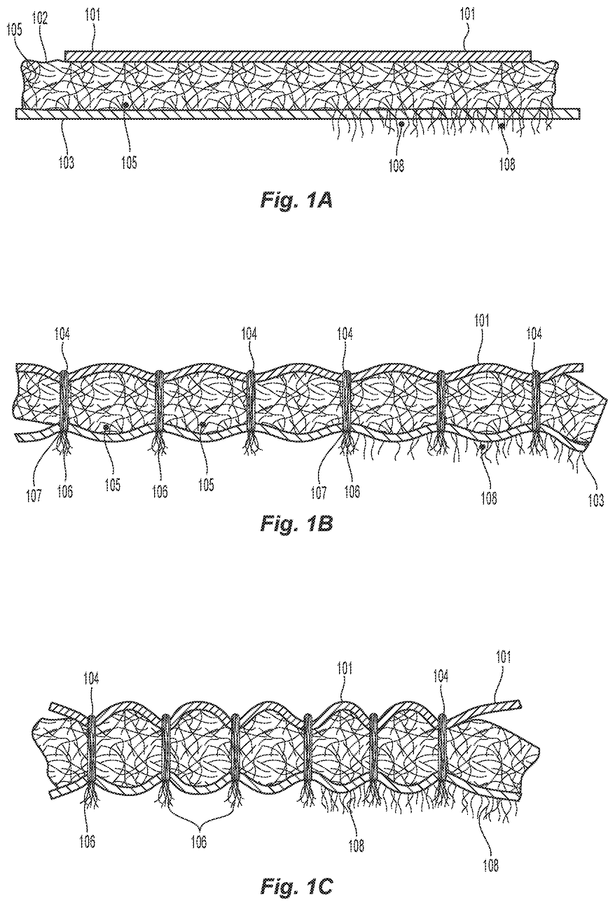

Referring an exemplary inventive stitched fabric shown in FIG. 1A, a dense hydrophobic layer 101 forming the outer layer is laid over bulky absorbent mid-layer 102 containing fibers 105. A hydrophobic, water repellent and highly air permeable open inner layer 103 then is then placed under the absorbent mid-layer 102. Referring to FIG. 1B, the three layers are stitched with yarns 104 as the stitch needles first enter the dense wind/water resistant layer 101. Some of the ends 106 of absorbent fibers 105 of the middle absorbent layer 102 are driven through at the stitching perforations 107 by the stitching needles and protrude beyond the highly open inner layer 103. Additionally, fibers 108 along the bottom of the mid-layer 102 are exposed through the openings of the lower open inner layer 103 between the stitched yarns/lines 104.

Referring to FIG. 1C, the stitching yarns 104 are shrunk with heat pinching the three layers 101, 102 and 103 and bulking the composite stitched fabric. The bulking process and the pressure of shrinking stitching yarns promotes further penetration of fiber ends 106 through the open inner layer 103.

Referring to the right-hand side of FIGS. 1A, 1B and 1C, limited amount and length of fibers 108 from middle layer 102 or from a separate absorbent layer similar to layer 102 may optionally be pre-inserted through the lower layer 103 in advance, e.g., by needle-punching, before the layering and stitching to further facilitate moisture pick up all along the entire interface. The needle-punching is preferably performed with finer needles to selectively drive in finer absorbent fibers such as rayon or lyocell, and to avoid driving higher denier stiff high-melt fibers such as polyester, to avoid inner surface roughness.

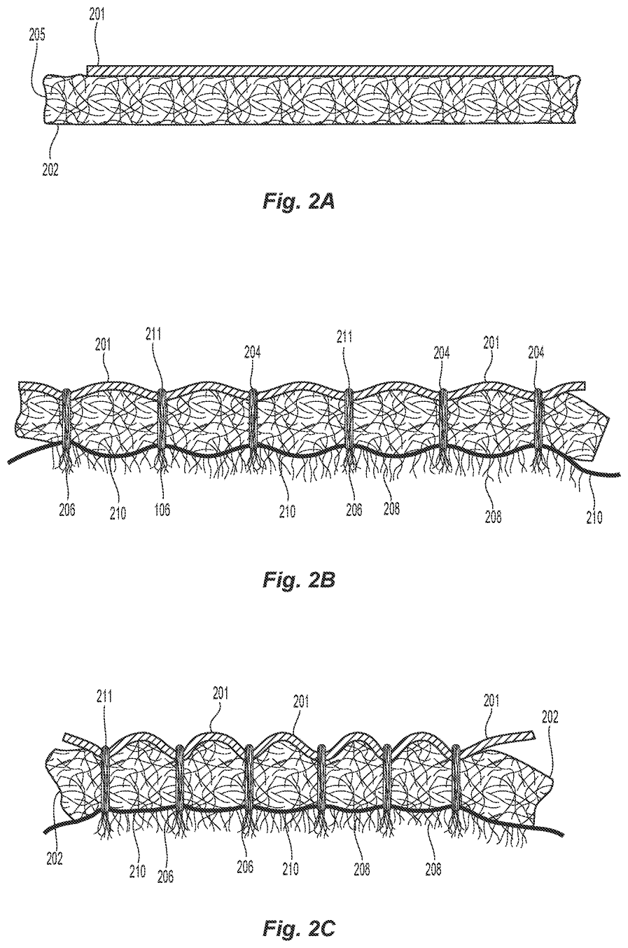

Referring to FIGS. 2A and 2B, the inner layer is formed in situ with underlaps 210 of stitching hydrophobic yarns, eliminating the need for adding a third fabric inner layer under outer wind/rain resistant layer 201 and bulky, absorbent mid-layer 202 with fibers 205. The two layers are stitched using preferably shrinkable linear “chain” or “pillar” or tricot stitches. The shrinkable yarns are preferably elastic and fed under tension. Alternatively, the stitching yarns are partially oriented shrinkable yarns (POY) also fed under tension. Underlaps 210 may be originating from the same stitch pattern as the yarn loops 211 holding the layers, or they may be laid-in, originating from a different stitching bar. The linear loops 211 or the underlaps 210 or both may be shrinkable, elastic or inelastic depending upon the need to bulk, tighten or elasticize the composite fabric. Along the stitched lines 204, fibers 206 from mid-layer 202 are driven beyond the lower surface. Fibers 208 of mid-layer 202 may also protrude through underlaps 201 between stitched lines 204, as shown.

As shown in FIG. 2C, the stitched assembly is optionally and preferably shrunk in one or both directions to increase bulk and durability. This also allows a larger amount or length of fibers 206 from the absorbent layer 202 to proceed beyond the underlap layer 210.

In all embodiments with two or three superposed layers, the option of flattening or texturing the lower surface by retouching with a heated flat or textured tool is available.

### EXAMPLE 1

OUTER LAYER: Tyvek type 800, 1.2 oz/yd² (32.7 g/m²) on the technical front as the hydrophobic, dense, outer layer. (Tyvek™ flash-spun polyethylene plexi-filament layer. Tyvek 800 is typically used to make disposable, chemical resistant protective coveralls, wind and rain resistant apparel, wind resistant house-wraps and similar products).

MIDDLE LAYER: Rayon 3-dpf 2.0-inch cut, carded/cross lapped into a 2.5 oz/yd² (84.75 g/m²) lightly needle-punched layer as the middle layer. (Rayon is a manufactured fiber made from natural sources such as wood and agricultural products that are regenerated as cellulose fiber.)

INNER LAYER: Sontara style 8034 spunlaced polyethylene terephthalate (PET) on the technical back with a basis weight of 0.75 oz/yd² (25.4 g/m²).

The three layers were stitched with 150-denier POY PET polyester, 14 gage 1-miss two or effectively 14/3 gage or 0.21 inch between stitches in XD, and 8 CPI or 0.125 inch between penetrations in MD, using a chain stitch pattern 10-01, and high tension. The stitched product had an overall thickness of about 1.2 mm and a basis weight of 4.4 oz/yd² (149.2 g/m²), resulting in an overall calculated density of 0.125 gram/cm³.

Subjected to one cycle of washing and drying on “hot” settings, the product shrunk by a ratio of 1.5:1 in MD and 1.1:1 in XD to a basis weight of 7.2 oz/yd² (244.1 g/m²). The bulked washed thickness was approximately 3.2 mm, and the overall calculated density was 0.08 g/cm³. Unless noted otherwise, all washing and drying in the Examples herein were conducted on “hot” settings.

After 5 more washing/drying cycles, there was no indication of surface wear and no further change in bulk.

The plexi-filamentary face of the technical front resisted water penetration as stitched, and to a much higher degree after bulking. The polyester PET face on the technical back absorbed water and transferred it to the middle absorbent layer without leaving a wet feel on the inner surface.

### EXAMPLE 2

Same as Example 1, except that there was a polyester tricot knit fabric approximately 18 gage and 18 CPI, weighing approximately 2.0 oz/yd² (67.8 g/m²) was used as the outer layer.

The stitched basis weight was 5.8 oz/yd² (196.6 g/m²); the stitched thickness was 1.6 mm, and the stitched density was 0.124 g/cm³. After one wash-dry cycle, the shrinkage was 1.3:1 in MD and the basis weight increased to 7.5 oz/yd² (254.3 g/m²). The thickness increased to 2.9 mm, and the calculated density decreased to 0.09 g/cm³.After 5 wash-dry cycles, the final properties were similar or substantially the same as to those of Example 1, with particularly excellent durability on both surfaces.

### EXAMPLE 3

Same as Example 1, but without a third inner layer on the technical back.

Laid-in 150-denier textured PET yarns with a 00-44 pattern were deployed on the technical back adding a weight of about 0.35 oz/yd² (11.9 g/m²), and resulting in a total stitched weight of 4.0 oz/yd² (135.6 g/m²), and a calculated density of 0.11 g/cm³.

After washing and MD shrinkage by about 1.4:1, the final basis weight was 5.6 oz/yd² (189.8 g/m²); the final thickness was 3.3 mm; and the final density was 0.06 g/cm³.

Compared to the wavy backsides in Examples 1 and 2, the technical back face was essentially flat after shrinking, and the product was softer and more pliable.

All other properties were similar to those in Examples 1 and 2.

### EXAMPLE 4

Same as Example 2 with the knit inner layer, except with Lycra/PET 70/50 stitching yarn instead of PET POY yarn. The stitched basis weight was 5.7 oz/yd² (193.2 g/m²) and the thickness was 1.4 mm.

After 1 wash-dry cycle and shrinkage in MD of 1.4:1, the basis weight was 7.6 oz/yd² and the thickness was 3.0 mm. The density was 0.08 g/cm³ with at least 40% elastic stretch.

### EXAMPLE 5

Same as Example 3, except that the chain stitching yarns were 70 denier Lycra yarns wrapped with 50 denier PET, deployed under tension.

As stitched and under MD tension to prevent shrinking, the basis weight was 3.8 oz/yd² (128.8 g/m²); the thickness was 1.1 mm; and the density was 0.12 g/cm³.

After 1 wash-dry cycle, the fabric shrunk 2:1 in MD, the basis weight was 7.6 oz/yd² (257.6 g/m²); the thickness increased to 3.2 mm; and the density decreased to 0.08 g/cm³.

There was no further change after 5 wash-dry cycles.

The shrunk and bulked product was elastically stretchable by 100% in MD. Furthermore, when the product was stretched by 50% to a basis weight of about 5.7 oz/yd² (193.2 g/m²), the thickness remained at the same 3.2 mm and at a density under 0.06 g/cm³, offering high heat insulation value when used in form-fitting apparel and stretches locally during wear.

This example shows one of the novel features of the present invention, i.e., after bulking and shrinking the stitched fabric can be partially stretched and sewn into a wind/rain resistant fabric that can locally stretched during wear to provide improved fitting as well as insulation to the wearers.

As used herein, DPF or denier per filament is the weight in grams of 9,000 meters of yarns/fibers. Gage is the needle spacing across per inch in XD and CPI is the number of needle penetrations per inch in MD. As used herein, the density values in the examples are calculated.

While it is apparent that the illustrative embodiments of the invention disclosed herein fulfill the objectives stated above, it is appreciated that numerous modifications and other embodiments may be devised by those skilled in the art. One such modification is that, in addition to a dense face layer, a bulky absorbent layer, and an open inner layer, any shrinkable or non-shrinkable layers can be placed between the two outer layers, and the assembly stitched with a combination of elastic or non-elastic shrinkable or non-shrinkable yarns, with optional added stitching bars of low melt fibers, low-melt yarns and added laid in stitches, to selectively adjust additional properties such as durability, bulk resilience, or abrasion resistance. Therefore, it will be understood that the appended claims are intended to cover all such modifications and embodiments, which would come within the spirit and scope of the present invention.

We claim:

1. A weather resistant and insulative stitched fabric comprising a hydrophobic, water and wind-resistant outer layer along a technical front, a hydrophilic, fibrous middle layer, and a hydrophobic, open inner layer along a technical back, wherein at least the outer and middle layers are stitched with stitching yarns,
wherein the outer layer has an initial Frazier air permeability value under about 5 ft³/ft²/minute,
wherein the open inner layer has planar openings exposing a lower surface of the middle layer,
wherein at least some of the fibers of the middle layer are projected at least through the inner layer through the stitching perforations, and wherein said projected fibers are capable of wicking moisture from below the inner layer through the middle layer and out of the outer layer, and
wherein an overall density of the stitched fabric is lower than about 0.25 g/cm³.

2. The stitched fabric of claim 1, wherein the open inner layer comprises underlap yarns originating from the stitching yarns along the technical back.

3. The stitched fabric of claim 1, wherein the stitching yarns are shrinkable and arranged along a machine direction (MD).

4. The stitched fabric of claim 1, wherein the middle layer includes absorbent or non-absorbent, virgin or reclaimed waste fibers of various lengths, deniers and orientations.

5. The stitched fabric of claim 2, wherein the underlap yarns originate from laid-in yarns.

6. The stitched fabric of claim 5, wherein the laid-in yarns are POY yarns, and the stitched fabric is shrunk in a cross direction (XD) by at least 10%.

7. The stitched fabric of claim 5, wherein the shrinkable stitched-in or laid-in yarns are elastic yarns, and the stitched fabric is shrunk in the MD or XD or both by at least 10%, and the stitched fabric is elastic in the MD or XD or both.

8. The stitched fabric of claim 7, wherein the bulked stitched fabric is capable of partially stretching in the MD or XD or both without a substantially loss of thickness.

9. The stitched fabric of claim 1, wherein the outer face layer comprises a plexi-filamentary nonwoven layer.

10. The stitched fabric of claim 1, wherein the outer face layer comprises a reinforced or nonreinforced polymeric film.

11. The stitched fabric of claim 1, wherein the face layer is printed.

12. The stitched fabric of claim 1, wherein the middle layer contains up to about 20% of high-melting fibers in the range from about 3 to about 15 dpf and from about 1.5 to about 4.0-inch cut length.

13. The stitched fabric of claim 12, wherein said high melting fibers have a melting point higher than that of all components of the stitched fabric.

14. The stitched fabric of claim 1 further comprising stitched holes without stitching yarns.

15. The stitched fabric of claim 1, wherein the middle layer contains up to 20% of low-melt single component fibers or bicomponent adhesive fibers providing a fiber content in the range from about 2% to about 15% that can melt at temperatures under about 200° C.

16. The stitched fabric of claim 1, wherein the stitching yarns comprise shrinkable yarns and yarns that have a melting point lower than all components of the stitched fabric.

17. The stitched fabric of claim 1, wherein the middle layer comprises a needle-punched felt.

18. The stitched fabric of claim 16, wherein at least some of the fibers from the middle layer are inserted into the inner layer between the stitching perforations, and wherein said inserted fibers are capable of wicking moisture from below the inner layer through the middle layer and out of the outer layer.

19. The stitched fabric of claim 1, wherein at least some of the fibers from the middle layer are pre-inserted into the inner layer, and wherein said inserted fibers are capable of wicking moisture from below the inner layer through the middle layer and out of the outer layer.

20. The stitched fabric of claim 1, wherein the stitched fabric is shrunk with heat or steam by at least about 10% in the MD or XD or both.
